(19) United States
(12) Patent Application Publication
(10) Pub. No.: US 2010/0208276 A1
(43) Pub. Date: Aug. 19, 2010

(54) APPARATUS, SYSTEM, METHOD AND PROGRAM FOR IMAGE PROCESSING

(75) Inventors: Kenji Murakami, Shiojiri-shi (JP); Iwane Ikeda, Nagano-shi (JP); Takashi Hyuga, Suwa-shi (JP); Kimitake Mizobe, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/707,201

(22) Filed: Feb. 17, 2010

(30) Foreign Application Priority Data
Feb. 17, 2009 (JP) 2009-033591

(51) Int. Cl. G06F 15/00; H04N 1/60

(52) U.S. Cl. 358/1.2; 358/1.9

(57) ABSTRACT

An image processing apparatus includes a data creating unit that creates image data in response to input data representing an image, wherein the image data includes first image data of a first pixel density and a second image data of a second pixel density lower than the first pixel density, and the data creating unit selects a representative color from colors included in the image, creates data, which includes information for specifying a high resolution pixel representing a portion indicating the representative color of the image among a plurality of high resolution pixels arranged with the first pixel density in an image area representing the image, as the first image data, and creates data, which includes a pixel value of a low resolution pixel representing a portion indicating a color different from the representative color of the image among a plurality of low resolution pixels arranged with the second pixel density in the image area, as the second image data.

### BACKGROUND

1. Technical Field

The present invention relates to an apparatus, a system, a method and a program for image processing.

2. Related Art

In the related art, various researches have been conducted to reduce the data amount while maintaining image quality. For example, there has been disclosed a technology for binarizing a character portion with a resolution of 360 dpi and resolution-converting a picture portion to 90 dpi. Further, there has been disclosed a technology, which uses a first image data plane representing color information of a character portion or a line drawing portion, a second image data plane representing a pattern such as a picture, and a selection data plane holding data used for selecting a first image plane with respect to pixels constituting characters and line drawings (see JP-A-08-139904 and JP-A-11-164153).

However, in the related art, researches for a method for reducing the data amount have not been sufficiently conducted.

### SUMMARY

An advantage of some aspects of the invention is to reduce the data amount.

The invention can be realized as the following forms or applications.

### Application 1

According to one aspect of the invention, there is provided an image processing apparatus including: a data creating unit that creates image data in response to input data representing an image, wherein the image data includes first image data of a first pixel density and second image data of a second pixel density lower than the first pixel density, and the data creating unit selects a representative color from colors included in the image, creates data, which includes information for specifying a high resolution pixel representing a portion indicating the representative color of the image among a plurality of high resolution pixels arranged with the first pixel density in an image area representing the image, as the first image data, and creates data, which includes a pixel value of a low resolution pixel representing a portion indicating a color different from the representative color of the image among a plurality of low resolution pixels arranged with the second pixel density in the image area, as the second image data.

According to the above configuration, the data, which includes the information for specifying the high resolution pixel representing the portion indicating the representative color of the image, is created as the first image data with the high pixel density, so that the data amount can be reduced. Further, the data, which includes the pixel value of the low resolution pixel representing the portion indicating the color different from the representative color of the image, is created as the second image data with the low pixel density, so that the data amount can be further reduced. Further, it is possible to express an image representing various colors by both the first image data and the second image data.

### Application 2

In the image processing apparatus according to application 1, the data creating unit specifies a multi-color low resolution pixel region of the image area, which includes the pixels of the first pixel density corresponding to one pixel of the second pixel density and having at least two colors, and selects a color, which is most frequently included in the multi-color low resolution pixel region among colors of the pixels of the first pixel density, as the representative color.

According to the above configuration, the color, which is most frequently included in the multi-color low resolution pixel region, is selected as the representative color, so that a wide image area is represented by the first image data with the high pixel density. As a result, a high definition image can be represented while reducing the data amount.

### Application 3

In the image processing apparatus according to application 1, the data creating unit selects the most common color visible among colors of the pixels of the first pixel density in the image area as the representative color.

According to the above configuration, the most common color visible among colors of the pixels of the first pixel density is selected as the representative color, so that a wide image area is represented by the first image data with the high pixel density. As a result, a high definition image can be represented while reducing the data amount.

### Application 4

In the image processing apparatus according to any one of applications 1 to 3, the data creating unit selects the second pixel density from a plurality of pixel density candidates prepared in advance to create the second image data such that a total number of colors, other than the representative color, of the pixels of the first pixel density is equal to or less than 1 in a region of the image area, which includes the pixels of the first pixel density corresponding to one pixel of the second pixel density.

According to the above configuration, the second pixel density is selected such that the total number of colors (except for the representative color) of the pixels of the first pixel density, which corresponds to one pixel of the second pixel density, is equal to or less than 1, so that an image representing various colors can be reliably represented by both the first image data and the second image data.

### Application 5

In the image processing apparatus according to any one of applications 1 to 3, when a total number of colors other than the representative color of the pixels of the first pixel density is equal to or larger than 2 in a region of the image area, which includes the pixels of the first pixel density corresponding to one pixel of the second pixel density, the data creating unit sets the pixel value of the low resolution pixel in the second image data as a value representing one color obtained by synthesizing colors other than the representative color.

According to the above configuration, when the total number of the colors (except for the representative color) of the pixels of the first pixel density, which corresponds to one pixel of the second pixel density, is equal to or larger than 2, the pixel value of the low resolution pixel is set as the value representing one color obtained by synthesizing colors other than the representative color, so that the data amount can be efficiently reduced.

### Application 6

In the image processing apparatus according to any one of applications 1 to 3, when a total number of colors other than the representative color of the pixels of the first pixel density is equal to or larger than 2 in a region of the image area, which includes the pixels of the first pixel density corresponding to one pixel of the second pixel density, the data creating unit selects one from the colors other than the representative color to set the pixel value of the low resolution pixel in the second image data as a value representing the selected color, and sets a pixel value of the high resolution pixel in a position, which represents a remaining color different from the representative color and the selected color, among the high resolution pixels in the first image data as a value representing the remaining color.

According to the above configuration, when the total number of the colors (except for the representative color) of the pixels of the first pixel density, which corresponds to one pixel of the second pixel density, is equal to or larger than 2, the pixel value of the low resolution pixel is set as the value representing one color selected from the two or more colors, and the pixel value of the high resolution pixel is set as the value representing the remaining color, so that an image representing various colors can be reliably represented by both the first image data and the second image data while reducing the data amount.

### Application 7

According to another aspect of the invention, there is provided an image processing system including: a data creating unit that creates image data in response to input data representing an image; and a data synthesizing unit, wherein the image data includes first image data of a first pixel density and a second image data of a second pixel density lower than the first pixel density, the data creating unit selects a representative color from colors included in the image, creates data, which includes information for specifying a high resolution pixel representing a portion indicating the representative color of the image among a plurality of high resolution pixels arranged with the first pixel density in an image area representing the image, as the first image data, and creates data, which includes a pixel value of a low resolution pixel representing a portion indicating a color different from the representative color of the image among a plurality of low resolution pixels arranged with the second pixel density in the image area, as the second image data, and the data synthesizing unit creates synthesized image data of the first pixel density, which represents the image, by synthesizing the first image data with the second image data, and creates the synthesized image data by selecting a pixel value representing a specified color in relation to the high resolution pixels in which the color is specified by the first image data, and by selecting a pixel value specified by the second image data in relation to the high resolution pixels in which the color is not specified by the first image data.

According to the above configuration, an image can be reliably reproduced from the first image data and the second image data.

### Application 8

According to further another aspect of the invention, there is provided a method of creating image data, the method including: creating the image data in response to input data representing an image, wherein the image data includes first image data of a first pixel density and a second image data of a second pixel density lower than the first pixel density, and the creating of the image data includes: selecting a representative color from colors included in the image; creating data, which includes information for specifying a high resolution pixel representing a portion indicating the representative color of the image among a plurality of high resolution pixels arranged with the first pixel density in an image area representing the image, as the first image data; and creating data, which includes a pixel value of a low resolution pixel representing a portion indicating a color different from the representative color of the image among a plurality of low resolution pixels arranged with the second pixel density in the image area, as the second image data.

### Application 9

According to yet another aspect of the invention, there is provided a computer program that causes a computer to execute a process of creating image data, the computer program causing the computer to perform a function of creating the image data in response to input data representing an image, wherein the image data includes first image data of a first pixel density and a second image data of a second pixel density lower than the first pixel density, and the function of creating the image data includes: selecting a representative color from colors included in the image; creating data, which includes information for specifying a high resolution pixel representing a portion indicating the representative color of the image among a plurality of high resolution pixels arranged with the first pixel density in an image area representing the image, as the first image data; and creating data, which includes a pixel value of a low resolution pixel representing a portion indicating a color different from the representative color of the image among a plurality of low resolution pixels arranged with the second pixel density in the image area, as the second image data.

### Application 10

According to still another aspect of the invention, there is provided an image processing apparatus including: a data synthesizing unit that synthesizes first image data of a first pixel density with a second Image data of a second pixel density lower than the first pixel density, thereby creating synthesized image data of the first pixel density representing an image, wherein the first image data includes information for specifying a high resolution pixel representing a portion indicating a representative color among a plurality of high resolution pixels arranged with the first pixel density in an image area representing the image, the second image data includes a pixel value of a low resolution pixel representing a portion indicating a color different from the representative color of the image among a plurality of low resolution pixels arranged with the second pixel density in the image area, and the data synthesizing unit selects a pixel value representing a specified color in relation to the high resolution pixels in which the color is specified by the first image data, and selects a pixel value specified by the second image data in relation to the high resolution pixels in which the color is not specified by the first image data, thereby creating the synthesized image data.

Hence, the invention can be realized in various forms. For example, the invention can be realized in a form such as an image processing method and apparatus, a computer program for executing the functions of the method and the apparatus, and a recording medium on which the computer program is recorded.

### BRIEF DESCRIPTION OF THE DRAWINGS

The invention will be described with reference to the accompanying drawings, wherein like numbers reference like elements.

FIG. 1 is a explanatory diagram illustrating an image processing system according to one embodiment of the invention.

FIG. 2 is a schematic view illustrating the creation of image data DHDL (also referred to as “image information DHDL”).

FIG. 3 is a schematic view illustrating the synthesis of image data.

FIG. 4 is a flowchart illustrating the sequence of creating (determining a pixel value) image data DHDL.

FIG. 5 is a schematic view illustrating an example of determining a pixel value.

FIG. 6 is a schematic view illustrating another example of determining a pixel value.

FIG. 7 is a schematic view illustrating an embodiment using an average color.

FIG. 8 is a schematic view illustrating an embodiment in which a pixel value is set in high resolution image data DH.

FIG. 9 is a schematic view illustrating the creation of image data DHDL according to another embodiment.

FIG. 10 is a schematic view illustrating the selection of a representative color according to another embodiment.

### DESCRIPTION OF EXEMPLARY EMBODIMENTS

Hereinafter, embodiments of the invention will be described according to the following sequence.
A. First Embodiment
B. Second Embodiment
C. Third Embodiment
D. Fourth Embodiment
E. Fifth Embodiment
F. Modified Example

### A. First Embodiment

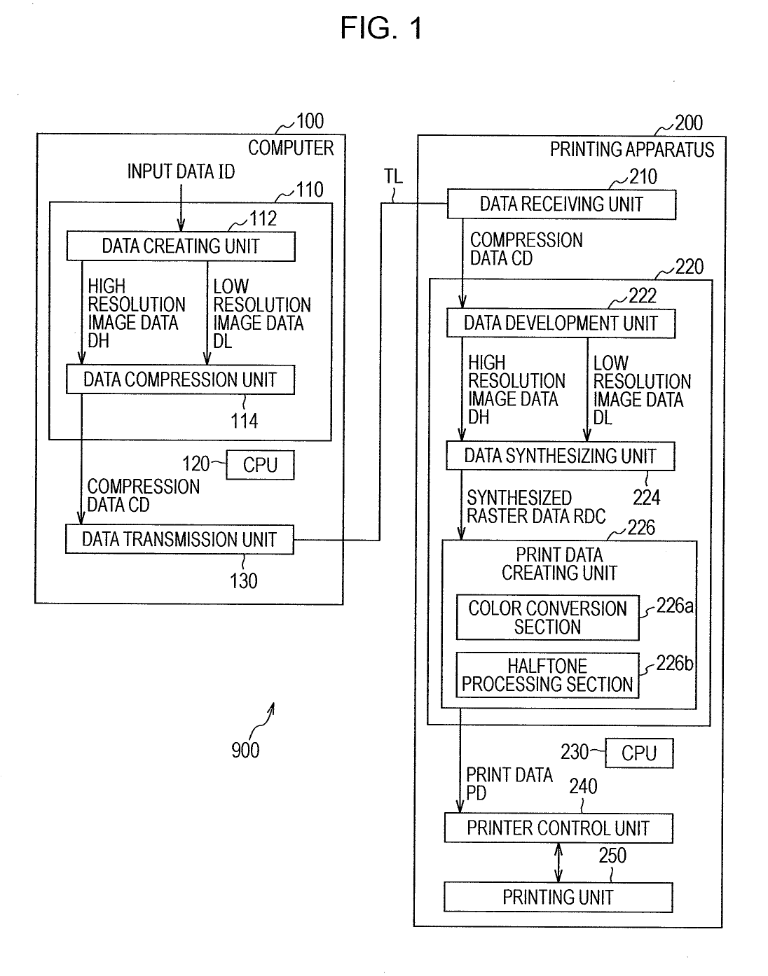

FIG. 1 is a block diagram illustrating an image processing system according to one embodiment of the invention. The image processing system 900 includes a computer 100 and a printing apparatus 200 connected to the computer 100 through a transmission path TL. In order to print an image represented by input data ID, the computer 100 develops the input data ID to create image data. As described later, the created image data includes high resolution image data DH and low resolution image data DL. The printing apparatus 200 prints the image in response to the image data received from the computer 100. The transmission path TL may employ various data communication lines such as USB cables and wired or wireless network.

The computer 100 includes a RAM 110, a CPU 120 and a data transmission unit 130. The RAM 110 stores a data creating unit 112 and a data compression unit 114. These processing units 112 and 114 denote computer program modules executed by the CPU 120. These modules 112 and 114 are developed in the RAM 110 from a non-volatile memory (not illustrated) such as a ROM and a hard disk drive. Hereinafter, the execution of a process by the CPU 120 according to the modules will be simply referred to as “the execution of the process by the module (e.g., the data creating unit 112)”. The data transmission unit 130 functions as an interface for connection to the transmission path TL.

The printing apparatus 200 includes a data receiving unit 210, a RAM 220, a CPU 230, a printer control unit 240 and a printing unit 250. The data receiving unit 210 functions as an interface for connection to the transmission path TL. The RAM 220 stores a data development unit 222, a data synthesizing unit 224 and a print data creating unit 226. These processing units 222, 224 and 226 denote computer program modules executed by the CPU 230. These modules 222, 224 and 226 are developed in the RAM 220 from a non-volatile memory (not illustrated) such as a ROM and a hard disk drive. Hereinafter, the execution of a process by the CPU 230 according to the modules will be simply referred to as “the execution of the process by the module (e.g., the data synthesizing unit 224)”. The print data creating unit 226 includes a color conversion section 226a and a halftone processing section 226b.

The printer control unit 240 controls the printing unit 250. The printing unit 250 functions as a printing mechanism that performs printing. The printing mechanism may employ various printing mechanisms such as printing mechanisms, which form an image by ejecting ink droplets onto a print sheet, and printing mechanisms which form an image by transferring and fixing toner onto a print sheet. According to the embodiment, the printer control unit 240 includes a dedicated electronic circuit.

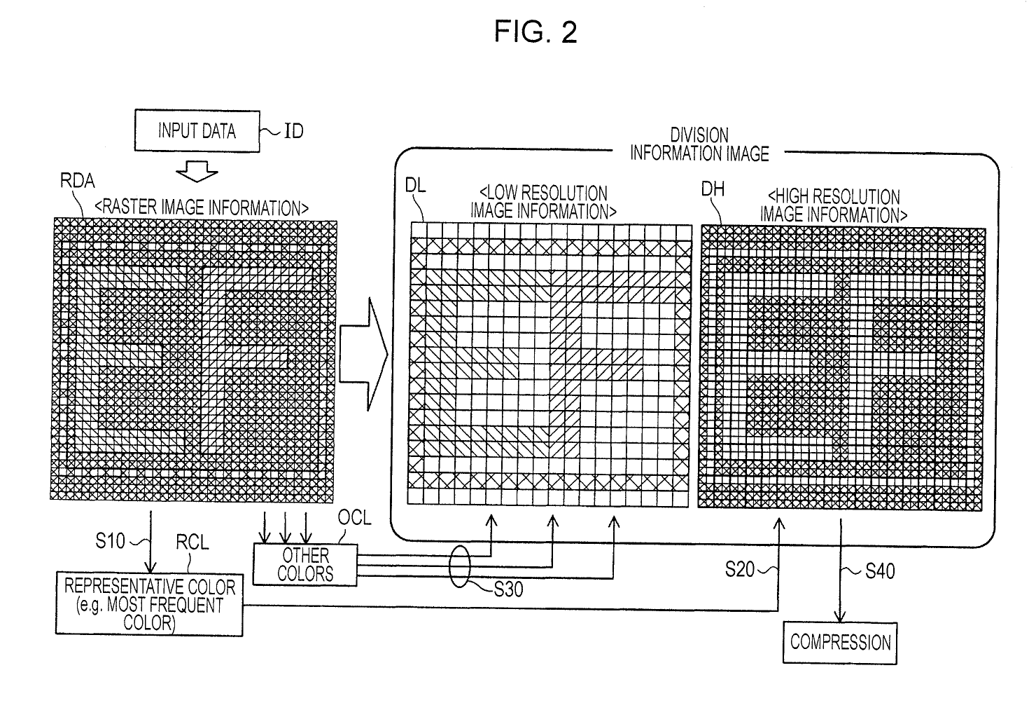

FIG. 2 is a schematic view illustrating the creation of the image data DH and DL (also referred to as “image information DH and DL”). The image data DH and DL is created by the data creating unit 112 of the computer 100 (FIG. 1). According to the embodiment, the data creating unit 112 analyzes the input data ID, thereby creating the image data DH and DL representing an image indicated by the input data ID. The left side of FIG. 2 illustrates original raster data RDA which serves as a source of the image data DH and DL. The “raster data” represents an image by determining a gray scale value in pixel units. Further, the lower side of FIG. 2 illustrates the process of creating the image data DH and DL.

According to the embodiment, the input data ID is PDL (Page Description Language) data described by a PDL. The PDL, for example, includes a postscript (a trademark of Adobe Systems Incorporated). Such PDL data includes one or more drawing commands. One drawing command represents one object to be drawn.

The object, for example, may include “characters”, “bitmap images” and “vector graphics other than characters”. The “characters” are a kind of the “vector graphics”. The vector graphics other than characters, for example, include line drawings or graphs. Hereinafter, the vector graphics other than characters will be referred to as “vector graphics of an image”, and an object other than characters among objects represented by the vector graphics will be referred to as “an object of an image”. Further, an object of a bitmap image will be referred to as a “bitmap image object” or will be simply referred to as a “bitmap object”.

The input data ID (PDL data) can be created by a document creation application (not illustrated) operating in the computer 100. Further, the input data ID may be supplied to the computer 100 from another data processing apparatus (not illustrated).

The data creating unit 112 (FIG. 1) can specify pixel values of each pixel with high resolution by high resolution rasterization according to the input data ID (PDL data). The original raster data RDA illustrated in the left side of FIG. 2 indicates the specified pixel values. In the same manner, the data creating unit 112 can specify pixel values of each pixel with low resolution by low resolution rasterization according to the input data ID (PDL data) (not illustrated). According to the embodiment, pixel values of the original raster data RDA are represented by gray scale values of R (red), G (green) and B (blue).

Further, the data creating unit 112 creates the high resolution image data DH and the low resolution image data DL by using the specified pixel values of each pixel with high resolution (details will be described later). As described above, the original raster data RDA is divided (analyzed) into the high resolution image data DH and the low resolution image data DL. Further, the data creating unit 112 may directly create the high resolution image data DH and the low resolution image data DL from the input data ID, without creating the original raster data RDA.

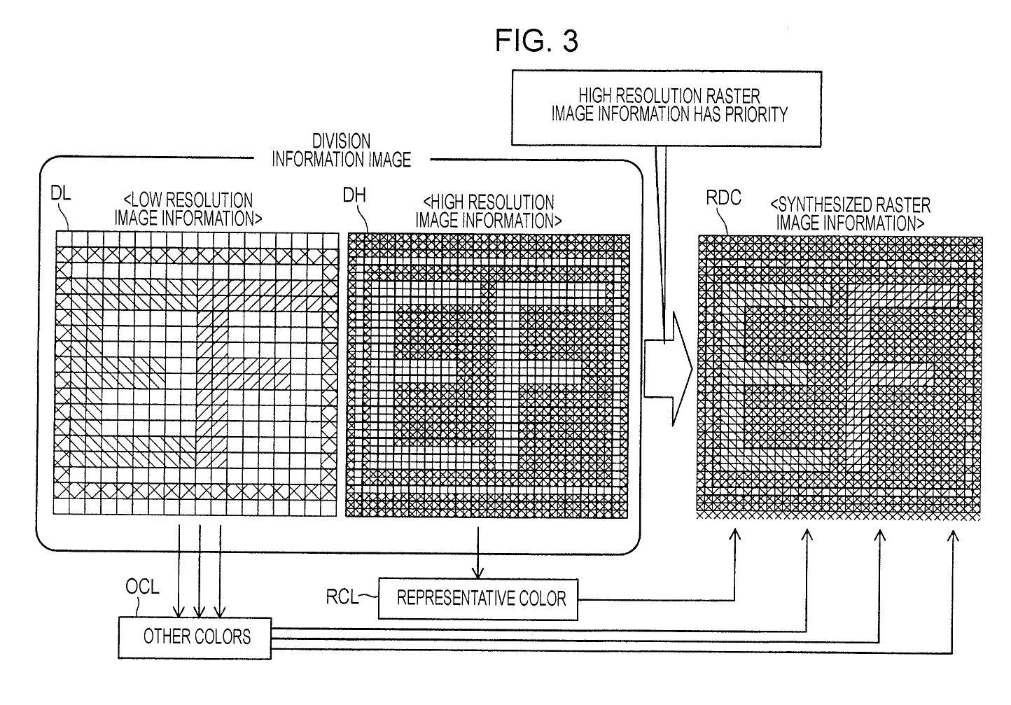

The high resolution image data DH and the low resolution image data DL indicate the same image area, which is represented by the input data ID, at resolutions (pixel densities) different from each other. The data DH and DL represent as a whole an image indicated by the input data ID. According to the embodiment, pixel density of the high resolution image data DH is a 2400 dpi and pixel density of the low resolution image data DL is a 600 dpi. If one low resolution pixel is selected, an area of (4×4) high resolution pixels included in the low resolution pixel is determined (it can be said that these high resolution pixels correspond to the low resolution pixel). Meanwhile, if one high resolution pixel is selected, one low resolution pixel including the high resolution pixel is determined (it can be said that the low resolution pixel corresponds to the high resolution pixel). Expression that “a plurality of pixels of a first pixel density correspond to one pixel of a second pixel density” according to the appended claims means that the pixels of the first pixel density are located in an area corresponding to one pixel of the second pixel density. In contrast, expression that “one pixel of the second pixel density corresponds to one pixel of the first pixel density” means that one pixel of the first pixel density is located in the area corresponding to one pixel of the second pixel density. Further, pixel density of the original raster data RDA is identical to that of the high resolution image data DH. The pixel density of each image data DH and DL as illustrated in FIG. 2 is not precise. FIG. 2 schematically illustrates that the pixel density of the high resolution image data DH is higher than that of the low resolution image data DL. This likewise applies to the image data DH and DL of FIG. 3 which will be described later.

According to the embodiment, the outline of the creation of the high resolution image data DH and the low resolution image data DL is as follows.

1) the data creating unit 112 selects one of colors included in an image (an image indicated by the input data ID, that is, an image indicated by the original raster data RDA) as a representative color (Step S10). According to the embodiment, among colors in a plurality of high resolution pixels (original raster data RDA) of the image (arranged in the image area), a color (the most frequent color), which are assigned to the most numerous pixels, is selected as the representative color.

2) the data creating unit 112 sets flags of each pixel of the high resolution image data DH (Step S20). In detail, a flag of a pixel (i.e., a pixel corresponding to a pixel indicating the representative color of the original raster data RDA) representing a portion indicating the representative color of the image is set to “1”, and flags of other pixels are set to “0”. As described above, the high resolution image data DH represents the flags of each pixel of the high resolution. Further, the data creating unit 112 initializes the flags of each pixel to “0”. Thereafter, in a process of determining a pixel value, the data creating unit 112 may set the flag to “1” if necessary.

3) among a plurality of pixels of the low resolution image data DL, the data creating unit 112 sets a pixel value in a pixel representing a portion indicating a color different from the representative color of the image (Step S30). The data creating unit 112 can determine a pixel value of the low resolution by rasterizing the input data ID with the low resolution.

In FIG. 2, pixels, to which pixel values or the flags have been set, are hatched. A color of the high resolution pixel having a flag of 1 is the representative color. A color of the high resolution pixel having a flag of 0 is represented by a corresponding pixel of the low resolution image data DL. The corresponding pixel is a low resolution pixel including a position of the high resolution pixel. Detailed description about the creation of each image data DH and DL will be given later.

The data compression unit 114 illustrated in FIG. 1 compresses the high resolution image data DH (S40 of FIG. 2). According to the embodiment, the high resolution image data DH represents flags of each pixel instead of gray scale values of each pixel. Thus, the data compression unit 114 can compress the high resolution image data DH with high efficiency by using simple compression such as run length encoding. According to the embodiment, the low resolution image data DL is not compressed. However, the low resolution image data DL may also be compressed.

The data compression unit 114 supplies the data transmission unit 130 with the whole (hereinafter, referred to as compression data CD) of the high resolution image data DH, the low resolution image data DL and data representing the gray scale value of the representative color. The data transmission unit 130 transmits the compression data CD to the printing apparatus 200 through the transmission path TL.

The data receiving unit 210 supplies the data development unit 222 with the received compression data CD. The data development unit 222 develops (decompresses) the received compression data CD to obtain the high resolution image data DH, the low resolution image data DL and the gray scale value of the representative color. The data synthesizing unit 224 synthesizes the high resolution image data DH with the low resolution image data DL, thereby creating synthesized raster data RDC.

FIG. 3 is a schematic view illustrating the synthesis of the image data. The synthesized raster data RDC represents an image indicated by the image data DH and DL (i.e., the input data ID of FIGS. 1 and 2). Further, the pixel density of the synthesized raster data RDC is identical to that of the high resolution image data DH. The data synthesizing unit 224 synthesizes the image data DH and DL in response to the flag of the high resolution image data DH, thereby creating the synthesized raster data RDC. According to the embodiment, the data synthesizing unit 224 performs the following processes with respect to each pixel of the synthesized raster data RDC. First, the data synthesizing unit 224 checks a flag of a first corresponding pixel of the high resolution image data DH corresponding to one target pixel of the synthesized raster data RDC. The first corresponding pixel and the target pixel are located at the same position. Next, when the flag has a value of “1”, the data synthesizing unit 224 selects a gray scale value (pixel value) representing the representative color as a pixel value of the target pixel. Last, when the flag has a value of “0”, the data synthesizing unit 224 selects a pixel value of a second corresponding pixel in the low resolution image data DL as the pixel value of the target pixel. The second corresponding pixel includes the target pixel.

The print data creating unit 226 illustrated in FIG. 1 analyzes the synthesized raster data RDC to create print data PD. The color conversion section 226a converts pixel values of each pixel of the synthesized raster data RDC into gray scale values of each ink used for the printing unit 250. For example, the pixel values of the synthesized raster data RDC are expressed by gray scale values of R (red), G (green) and B (blue). Further, the printing unit 250 uses each ink of C (cyan), M (magenta), Y (yellow) and K (black). In such a case, the color conversion section 226a converts the gray scale values of the R, G and B into the gray scale values of C, M, Y and K. The halftone processing section 226b performs a halftone process according to the gray scale values of each ink. Further, the halftone processing section 226b creates the print data PD according to the result of the halftone process.

The print data creating unit 226 supplies the printer control unit 240 with the created print data PD. The printer control unit 240 controls the printing unit 250 in response to the print data PD. In this way, the printing unit 250 prints the image. The whole of the print data creating unit 226, the printer control unit 240 and the printing unit 250 correspond to “a printing section”.

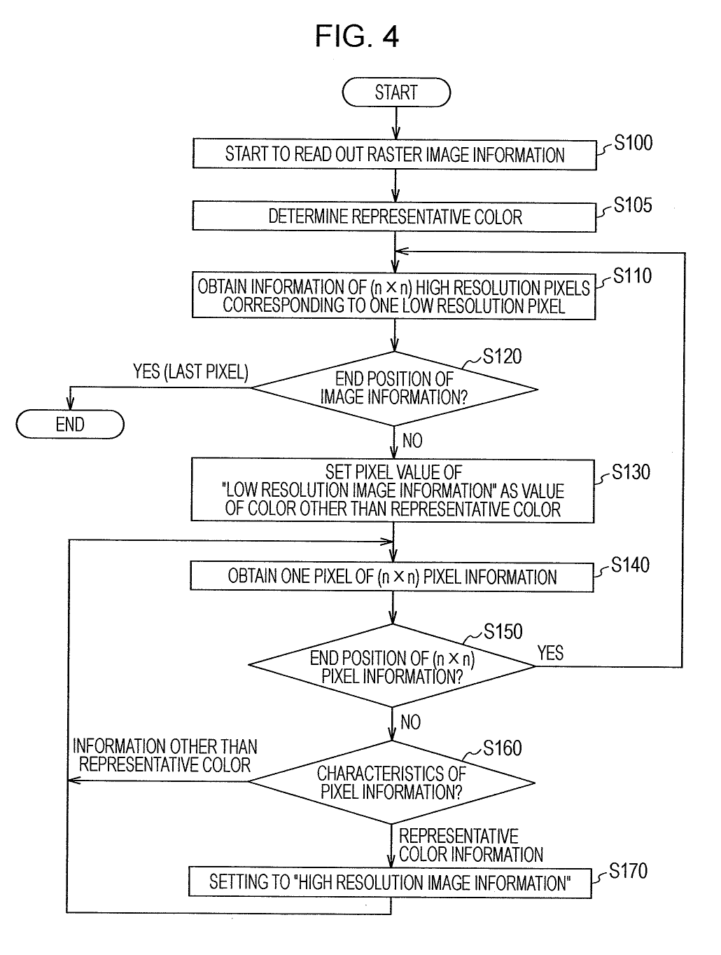

FIG. 4 is a flowchart illustrating the sequence of creating (determining a pixel value) the image data DH and DL. First, in Step S100, the data creating unit 112 (FIG. 1) starts to read out the original raster data RDA (FIG. 2). Next, in Step S105, the data creating unit 112 determines the representative color. According to the embodiment, the representative color denotes a color with the maximum number of pixels among colors of the high resolution pixels.

Then, in Step S110, the data creating unit 112 selects one low resolution pixel to obtain pixel values of (n×n) high resolution pixels corresponding to the selected low resolution pixel (n is an integer equal to or larger than 2 and has a value of 4 in the embodiment). The low resolution pixels corresponds to pixels of the low resolution image data DL, and the high resolution pixels correspond to pixels of the high resolution image data DH. Hereinafter, the selected one low resolution pixel will be referred to as a “target low resolution pixel”. The target low resolution pixel is selected in a predetermined sequence from the low resolution pixels. The data creating unit 112 performs processes of Step S120, S130, S140, S150, S160 and 170, which will be described later, with respect to the respective low resolution pixels. When all the low resolution pixels have been completely processed (i.e., when the last pixel of the image data has been completely processed) in the case of “Yes” in Step S120, the data creating unit 112 completes the creation of the image data DH and DL.

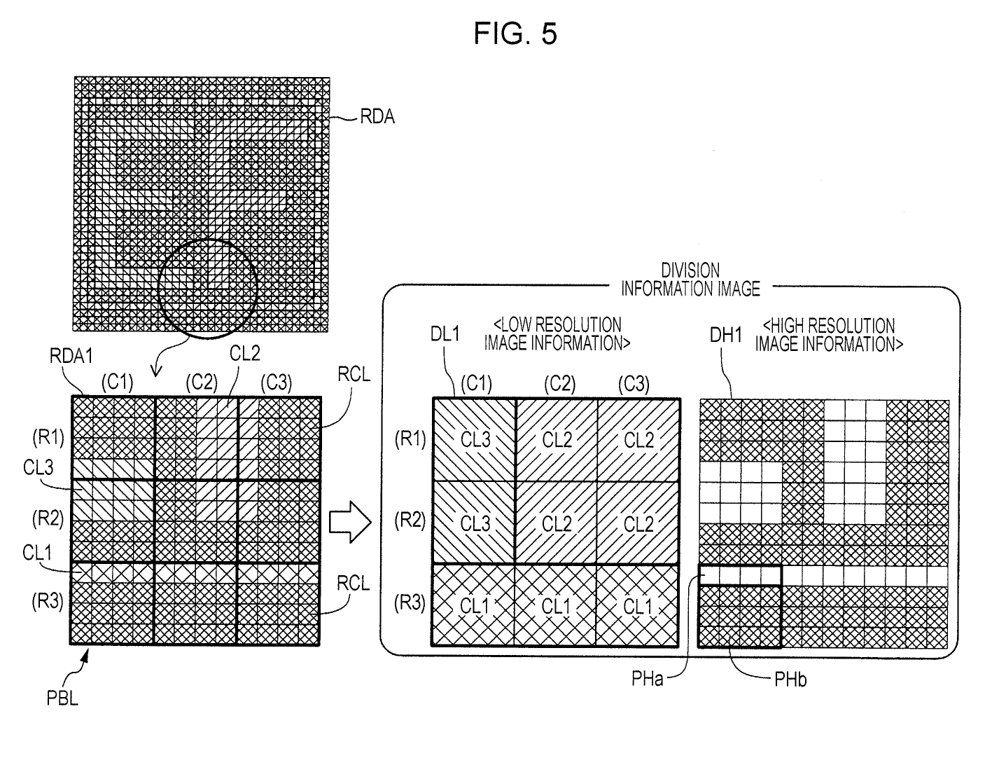

FIG. 5 is a schematic view illustrating an example of determining a pixel value. The left upper portion of FIG. 5 illustrates the original raster data RDA, the left lower portion of FIG. 5 illustrates a first partial area RDA1 of the original raster data RDA, and the right portion of FIG. 5 illustrates partial areas DH1 and DL1, which represent areas identical to the partial area RDA1, in the respective image data DH and DL. The first partial area RDA1 denote an area of (3×3) low resolution pixels, that is, an area of (12×12) high resolution pixels. In the partial areas RDA1 and DL1, row numbers R1 to R3 and column numbers C1 to C3 are illustrated. Hereinafter, one low resolution pixel is expressed by the combination of the row numbers and the column numbers (e.g., a pixel PBL at the left lower corner will be referred to as a pixel R3C1).

Each color of the high resolution pixels in the first partial area RDA1 is set to have any one of a representative color RCL, a first color CL1, a second color CL2 and a third color CL3. In FIG. 5, the colors RCL, CL1, CL2 and CL3 are differently hatched. In the example of FIG. 5, each of the left upper two low resolution pixels R1C1 and R2C1 is expressed by the high resolution pixels of the representative color RCL and the high resolution pixels of the third color CL3 (i.e., each of the two low resolution pixels R1C1 and R2C1 includes only the representative color RCL and third color CL3). Each of the lowermost three low resolution pixels R3C1, R3C2 and R3C3 includes only the representative color RCL and first color CL1. Each of the remaining four low resolution pixels R1C2, R2C2, R1C3 and R2C3 includes only the representative color RCL and second color CL2.

In Step S130 of FIG. 4, the data creating unit 112 (FIG. 1) sets the pixel value of the target low resolution pixel of the low resolution image data DL as a value of a color other than the representative color among colors included in the target low resolution pixel. For example, the pixel R3C1 (the pixel PBL) at the left lower corner in the first partial area RDA1 includes one color (the first color CL1) in addition to the representative color RCL. Thus, the data creating unit 112 sets the pixel value of the pixel R3C1, which corresponds to the partial area DL1 of the low resolution image data DL, as a value representing the first color CL1. Further, there occurs a case in which the total number of colors other than the representative color RCL is equal to or larger than 2 among the colors included in the target low resolution pixel. Such a case will be described later.

In Step S140 of FIG. 4, the data creating unit 112 (FIG. 1) selects one of the high resolution pixels included in the target low resolution pixel and obtains the pixel value of the selected pixel. Hereinafter, the selected one high resolution pixel will be referred to as a “target high resolution pixel”. The target high resolution pixel is selected in a predetermined sequence from the high resolution pixels. The data creating unit 112 performs processes of Step S150, S160 and S170, which will be described later, with respect to the respective high resolution pixels included in the target low resolution pixel. When all the high resolution pixels (16 high resolution pixels in the embodiment) have been completely processed (i.e., when the last pixel of the (n×n) pixels has been completely processed) in the case of “Yes” in Step S150, the data creating unit 112 returns to Step S110.

In Step S160 of FIG. 4, the data creating unit 112 compares the characteristics (in detail, a color. Hereinafter, referred to as a “target color”) of the target high resolution pixel with the representative color. When the target color is different from the representative color, the data creating unit 112 returns to Step S140. According to the embodiment, when a gray scale value of the same color component is different between the target color and the representative color, it is determined that the target color is different from the representative color.

When the target color is identical to the representative color, the data creating unit 112 (FIG. 1) sets a flag of the target high resolution pixel of the high resolution image data DH to “1” in Step S170. Then, the data creating unit 112 returns to Step S140.

In this way, setting of flags according to the result obtained by comparing the colors is performed with respect to the respective high resolution pixels included in the target low resolution pixel. For example, in relation to the low resolution pixel R3C1 at the left lower corner of the partial area RDA1 in FIG. 5, flags of four high resolution pixels Pha in the uppermost one row in the partial area DH1 of high resolution are maintained to “0”, and flags of 12 high resolution pixels Phb in the remaining three rows are set to “1”.

Similarly to this, pixel values and flags are set in other low resolution pixels. When creating the synthesized raster data RDC of an image part illustrated in FIG. 5, the data synthesizing unit 224 (FIG. 1) performs the following processes. In relation to the high resolution pixel (pixel of the synthesized raster data RDC) in which the flag of the corresponding pixel of the high resolution image data DH has a value of “1”, the data synthesizing unit 224 selects the gray scale value of the representative color. For example, since the flag has a value of “1” in the second region Phb of FIG. 5, the gray scale value of the representative color is selected. In relation to the high resolution pixels in which the flag of the corresponding pixel has a value of “0”, the data synthesizing unit 224 selects the gray scale value of the color of the corresponding pixel of the low resolution image data DL. For example, since the flag has a value of “0” in the first region PHa of FIG. 5, the gray scale value of the color (the first color CL1) of the corresponding pixel R3C1 of the low resolution image data DL (the partial area DL1 of FIG. 5) is selected.

There occurs a case in which the total number of colors other than the representative color is equal to or larger than 2 among the colors included in one target low resolution pixel. In such a case, according to the embodiment, pixel values and flags are determined as follows.

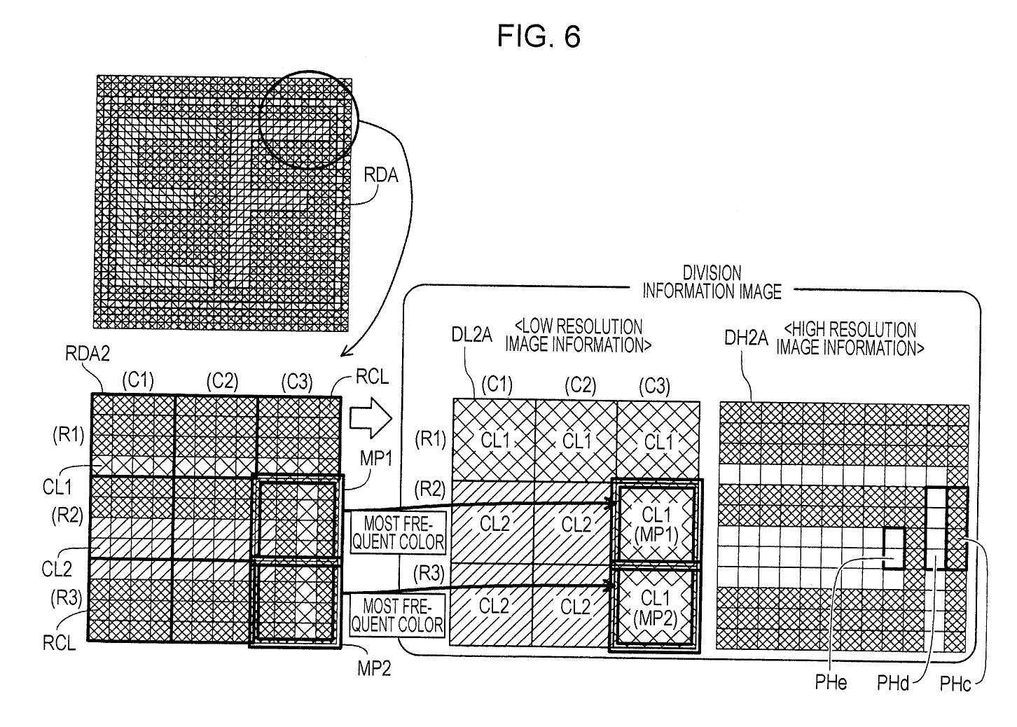

FIG. 6 is a schematic view illustrating another example of determining a pixel value. Similarly to FIG. 5, FIG. 6 illustrates the original raster data RDA, a second partial area RDA2 of the original raster data RDA, and partial areas DH2A and DL2A in the respective image data DH and DL, which denote areas identical to the partial area RDA2. The second partial area RDA2 denotes a region of (3×3) low resolution pixels. Further, the second partial area RDA2 denotes a portion different from the first partial area RDA1 of FIG. 5.

The respective high resolution pixels in the second partial area RDA2 are set as any one of the representative color RCL, the first color CL1 and the second color CL2. Referring to FIG. 6, the colors RCL, CL1 and CL2 are differently hatched. In the example of FIG. 6, each of the uppermost three low resolution pixels R1C1, R1C2 and R1C3 includes only the representative color RCL and the first color CL1. Each of the left lower four low resolution pixels R2C1, R2C2, R3C1 and R3C2 includes only the representative color RCL and the second color CL2. Each of the right lower two low resolution pixels R2C3 and R3C3 includes the colors CL1 and CL2 in addition to the representative color RCL. Hereinafter, theses pixels R2C3 and R3C3 will be referred to as a “pixel MP1” and a “pixel MP2”, respectively.

In relation to target low resolution pixels (e.g., first and second pixels MP1 and MP2) including a plurality of colors in addition to the representative color RCL, in Step S130 of FIG. 4, the data creating unit 112 (FIG. 1) determines the pixel value of the target low resolution pixel of the low resolution image data DL as follows. The data creating unit 112 sets the pixel value of the target low resolution pixel as a value representing a color (most frequent color), which are assigned to the most numerous high resolution pixels, among the colors other than the representative color RCL. For example, the first pixel MP1 of FIG. 6 includes the first color CL1 and the second color CL2 in addition to the representative color RCL. The number of pixels with the first color CL1 is “4” and the number of pixels with the second color CL2 is “2”. A color, which is assigned to the most numerous pixels, is the first color CL1. Thus, the pixel value of the pixel R2C3 (pixel corresponding to the first pixel MP1) in the partial area DL2A is set to the value of the first color CL1. A flag of the high resolution pixel representing the representative color RCL is set to “1” regardless of the total number of the colors other than the representative color RCL. Similarly to this, pixel values and flags are set in the second pixel MP2. There occurs a case in which plural most frequent colors exist in one target low resolution pixel. In such a case, the data creating unit 112 may arbitrarily select one from the plural most frequent colors. A method of selecting the most frequent color can be implemented in various ways.

When creating the synthesized raster data RDC of the image part illustrated in FIG. 6, the data synthesizing unit 224 (FIG. 1) performs the following processes. In relation to the high resolution pixel (pixel of the synthesized raster data RDC) in which the flag of the corresponding pixel of the high resolution image data DH has a value of “1”, the data synthesizing unit 224 selects the gray scale value of the representative color. For example, since the flag has a value of “1” in the first region PHc indicated by the thick line of FIG. 6, the gray scale value of the representative color is selected. In relation to the high resolution pixels in which the flag of the corresponding pixel has a value of “0”, the data synthesizing unit 224 selects the gray scale value of the color of the corresponding pixel of the low resolution image data DL. For example, since the flag has a value of “0” in the second region PHd and the third region PHe indicated by the thick line of FIG. 6, the gray scale value of the color (the first color CL1) of the corresponding pixel R2C3 of the low resolution image data DL (the partial area DL2A of FIG. 6) is selected. As described above, in relation to a part (e.g., pixels in the third region Phe of FIG. 6) of the high resolution pixels, a color different from the original color is selected. However, according to the embodiment, since the most frequent color is set in the low resolution image data DL, the number of the high resolution pixels in which a color is changed can be reduced. As a result, uncomfortableness of a user who observes an image reproduced from the image data DH and DL can be reduced.

According to the embodiment as described above, data, which includes information (flags) for specifying high resolution images representing portions indicating the representative color of the image, is created as the high resolution image data DH of a high pixel density, so that the data amount can be reduced as compared with the case in which all high resolution images have gray scale values. Further, data, which includes pixel values of low resolution images representing portions indicating colors different from the representative color of the image, is created as the low resolution image data DL of a low pixel density, so that the data amount can be further reduced. Furthermore, in relation to low resolution pixels of including a plurality of colors in addition to the representative color RCL, a gray scale value of one color is set in the low resolution pixels of the low resolution image data DL, so that the data amount can be effectively reduced. Moreover, it is possible to express an image representing various colors by both the high resolution image data DH and the low resolution image data DL.

Further, since the most common color visible among respective colors of high resolution pixels is selected as the representative color, a wide image area is represented by the high resolution image data DH. As a result, a high definition image can be represented while reducing the data amount.

### B. Second Embodiment

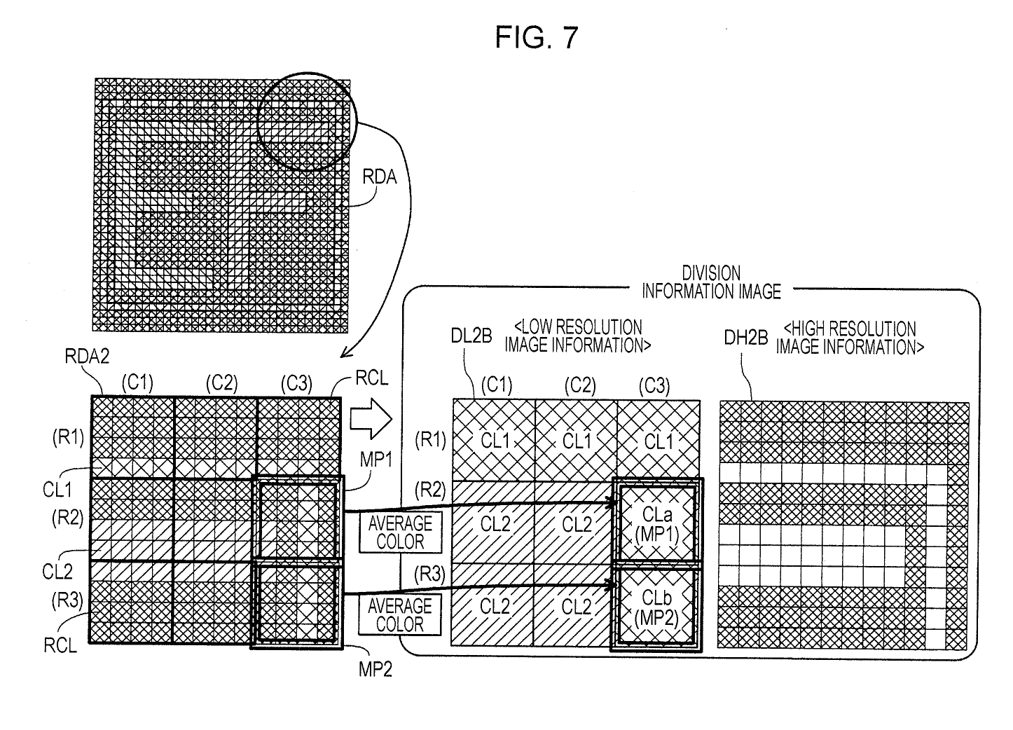

Differently from the embodiment as illustrated in FIG. 6, an average color may be employed instead of the most frequent color. FIG. 7 is a schematic view illustrating the second embodiment using the average color. The second embodiment is substantially identical to the embodiment as illustrated in FIG. 6, except that the average color is used instead of the most frequent color when the total number of colors other than a representative color among colors included in a target low resolution pixel is equal to or larger than 2. FIG. 7 illustrates the original raster data RDA and the second partial area RDA2 which are identical to those of FIG. 6. Further, in the respective image data DH and DL, partial areas DH2B and DL2B, which represent areas identical to the second partial area RDA2, are illustrated.

The data creating unit 112 sets a pixel value of a target low resolution pixel including plural colors in addition to the representative color RCL as a value representing an average color of the colors other than the representative color RCL. For example, the first pixel MP1 of FIG. 7 includes the first color CL1 and the second color CL2, in addition to the representative color RCL. The number of pixels with the first color CL1 is “4” and the number of pixels with the second color CL2 is “2”. Thus, a pixel value of a pixel R2C3 (corresponds to the first pixel MP1) in the partial area DL2B is set as a value representing an average color CLa obtained from the four first color CL1 and the two second color CL2. The average color is represented by an average value of gray scale values of each color component. Similarly to this, a pixel value of a pixel R3C3 corresponding to the second pixel MP2 is set as a value representing an average color CLb.

According to the embodiment, the high resolution image data DH is created similarly to the first embodiment as illustrated in FIG. 6. Thus, the partial area DH2B is identical to the partial area DH2A of FIG. 6. That is, the high resolution image data DH of the embodiment is identical to the high resolution image data DH of the first embodiment.

As described above, according to the embodiment, in relation to the target low resolution pixel including the colors in addition to the representative color RCL, one color (average color) is set in the low resolution image data DL. As a result, the uncomfortableness of a user who observes an image reproduced from the image data DH and DL can be reduced. Further, the data amount can be effectively reduced.

### C. Third Embodiment

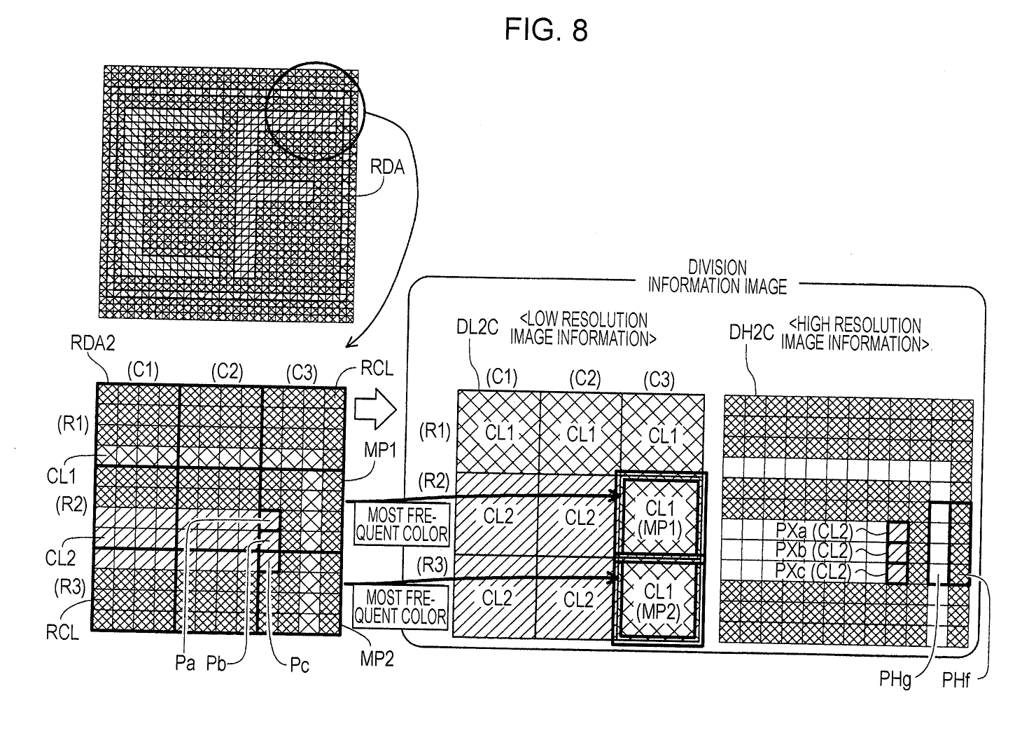

Differently from the embodiment as illustrated in FIG. 6, among plural high resolution pixels in one target low resolution pixel, in relation to a high resolution pixel representing a color different from both the representative color RCL and the color set in the low resolution image data DL, a pixel value may also be set in the high resolution image data DH (the color different from the two colors corresponds to the “remaining color” according to the appended claims). FIG. 8 is a schematic view illustrating the third embodiment in which the pixel value is set in the high resolution image data DH. The third embodiment is substantially identical to the embodiment as illustrated in FIG. 6, except that a pixel value representing the remaining color is set in a pixel representing the remaining color of the high resolution image data DH. FIG. 8 illustrates the original raster data RDA and the second partial area RDA2 which are identical to those of FIG. 6. Further, in the respective image data DH and DL, partial areas DH2C and DL2C, which represent areas identical to the second partial area RDA2, are illustrated. Three pixels Pa, Pb and Pc in the second partial area RDA2 correspond to pixels representing the remaining color, respectively. A representative color is common in all low resolution pixels of the image (arranged in the image area), and colors set in the low resolution image data DL are different in each low resolution pixel. Thus, the remaining color is different in each low resolution pixel.

The data creating unit 112 sets a pixel value of a target low resolution pixel including plural colors in addition to the representative color RCL as a value representing the most frequent color similarly to the first embodiment as illustrated in FIG. 6. For example, a pixel value of a pixel R2C3 (corresponds to the first pixel MP1) in the partial area DL2C of FIG. 8 is set as a value representing the first color CL1. Similarly to this, a pixel value of a pixel R3C3 (corresponds to the second pixel MP2) in the partial area DL2C of FIG. 8 is set as a value representing the first color CL1. That is, the low resolution image data DL of the embodiment is identical to the low resolution image data DL of the first embodiment.

In addition, in relation to a high resolution pixel representing the remaining color, the data creating unit 112 sets a pixel value in the high resolution image data DH. Three pixels PXa, PXb and PXc are illustrated in the partial area DH2C of FIG. 8. These pixels PXa, PXb and PXc correspond to the pixels Pa, Pb and Pc in the second partial area RDA2, respectively. The data creating unit 112 sets a pixel value in the pixels PXa, PXb and PXc of the high resolution image data DH (the partial area DH2C). Pixel values of the corresponding pixels Pa, Pb and Pc in the second partial area RDA2 is employed as the pixel value, respectively.

When creating the synthesized raster data RDC of an image part illustrated in FIG. 8, the data synthesizing unit 224 (FIG. 1) performs the following processes. In relation to the high resolution pixel (pixel of the synthesized raster data RDC) in which the flag of the corresponding pixel of the high resolution image data DH has a value of “1”, the data synthesizing unit 224 selects the gray scale value of the representative color. For example, since the flag has a value of “1” in the first region PHf indicated by a thick line of FIG. 8, the gray scale value of the representative color is selected. In relation to the high resolution pixels in which the flag of the corresponding pixel has a value of “0”, the data synthesizing unit 224 selects the gray scale value of the color of the corresponding pixel of the low resolution image data DL. For example, since the flag has a value of “0” in the second region PHg indicated by a thick line of FIG. 8, the gray scale value of the color (the first color CL1) of the corresponding pixel R2C3 of the low resolution image data DL (the partial area DL2C of FIG. 8) is selected. In relation to the high resolution pixels in which pixel values are set in corresponding pixels, the data synthesizing unit 224 selects the pixel values. For example, in relation to three pixels PXa, PXb and PXc of FIG. 8, the pixel values of these pixels are employed as the pixel values of the synthesized raster data RDC.

As described above, according to the embodiment, in relation to the remaining color, pixel values are set in the high resolution image data DH, so that an image representing various colors can be reliably represented by both the high resolution image data DH and the low resolution image data DL. Further, the most frequent color is set in the low resolution image data DL, so that the number of high resolution pixels representing the remaining color can be reduced. As a result, the data amount can be effectively reduced.

### D. Fourth Embodiment

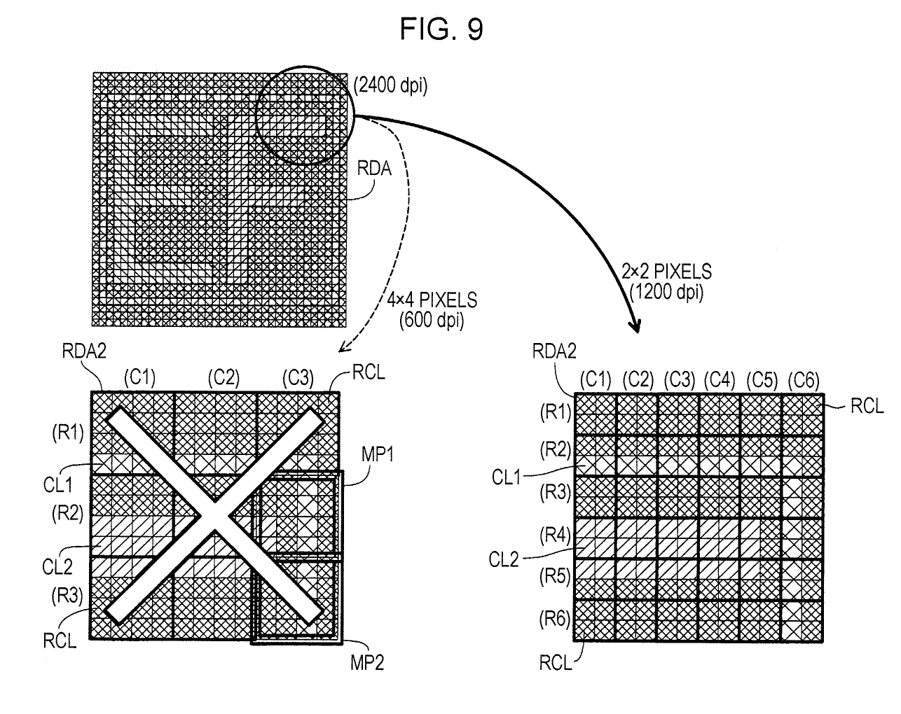

FIG. 9 is a schematic view illustrating the creation of the image data DH and DL according to another embodiment. According to the embodiment, the data creating unit 112 (FIG. 1) selects pixel density of the low resolution image data DL from plural candidates prepared in advance according to the original raster data RDA. The selection is performed such that the total number of colors other than the representative color among colors include in one low resolution pixel is equal to or less than 1.

According to the embodiment, the pixel density of the low resolution image data DL includes a “600 dpi” and a “1200 dpi”. Pixel density of the high resolution image data DH (that is, original raster data RDA) is fixed at 2400 dpi. FIG. 9 illustrates the original raster data RDA and the second partial areas RDA2 which are identical to those of FIG. 6. In the second partial area RDA2 located at the left lower portion of the FIG. 9, low resolution pixels of 600 dpi are indicated by a thick line. In the second partial areas RDA2 located at the right lower portion of the FIG. 9, low resolution pixels of 1200 dpi are indicated by a thick line.

First, the data creating unit 112 checks the existence or absence of a low resolution pixel including plural colors in addition to the representative color according to the low pixel density (600 dpi). In the example of FIG. 9, two pixels MP1 and MP2 include colors CL1 and CL2 in addition to the representative color RCL. Next, the data creating unit 112 checks the existence or absence of a low resolution pixel including plural colors in addition to the representative color according to another candidate (1200 dpi). In the example of FIG. 9, in relation to all pixels of high resolution (1200 dpi), the total number of colors other than the representative color RCL is equal to or less than 1. Then, the data creating unit 112 employs the candidate (1200 dpi). Last, the data creating unit 112 creates the image data DH and DL according to the selected candidate (pixel density), similarly to the first embodiment as illustrated in FIGS. 4 and 5.

According to the embodiment, the pixel density of the low resolution image data DL is selected such that the total number of colors (except for the representative color) included in one low resolution pixel is equal to or less than 1, so that an image representing various colors can be reliably represented by both the high resolution image data DH and the low resolution image data DL.

Plural pixel densities prepared in advance may be employed as the candidate of the pixel density of the low resolution image data DL. Further, the total number of candidates is not limited to 2, and an arbitrary plural number may be employed. For example, in the embodiment of FIG. 9, a “1200 dpi”, a “800 dpi” and a “600 dpi” may also be employed as a candidate. In any case, among candidates (pixel densities) satisfying the condition that, in relation to respective low resolution pixels (arranged in the image area) of the image, the total number of colors other than the representative color among colors included in one low resolution pixel is equal to or less than 1, the data creating unit 112 preferably selects the lowest pixel density. In this way, the data amount of the low resolution image data DL can be effectively reduced.

### E. Fifth Embodiment

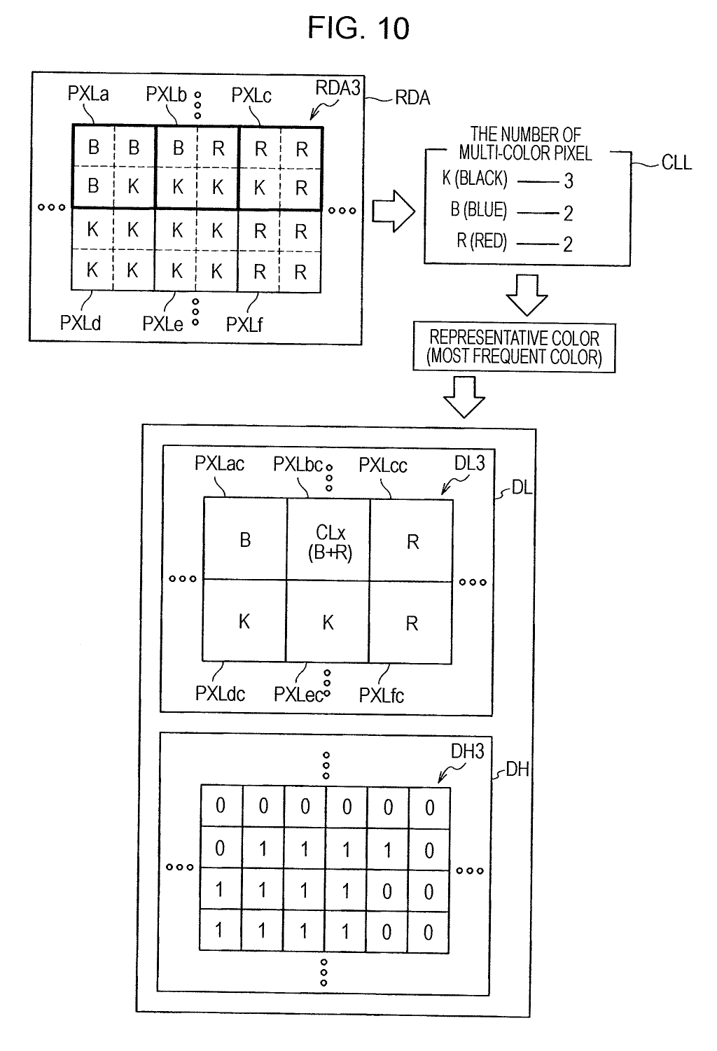

FIG. 10 is a schematic view illustrating the selection of the representative color according to another embodiment. This selection can be applied to the previous embodiments. In the embodiment, the data creating unit 112 first specifies low resolution pixels (multi-color low resolution pixels), in which the total number of colors included in one low resolution pixel is equal to or larger than 2, from a plurality of low resolution pixels (arranged in the image area) of the image. Then, the data creating unit 112 selects a color, which is most frequently included in the multi-color low resolution pixels, among colors included in the multi-color low resolution pixels as the representative color.

FIG. 10 illustrates a partial area RDA3 of the original raster data RDA, a list CLL of the colors included in the multi-color low resolution pixels, the representative color RCL, and partial areas DH3 and DL3, which represent areas identical to the partial area RDA3, in the respective image data DH and DL. In the example of FIG. 10, pixel density of the high resolution image data DH is a 2400 dpi and pixel density of the low resolution image data DL is a 1200 dpi. One low resolution pixel corresponds to an area of 4(2×2) high resolution pixels. Further, the partial area RDA3 represents an area (i.e., an area of (4×6) high resolution pixels) of (2×3) low resolution pixels. In the partial area RDA3, the low resolution pixels are indicated by a solid line and the high resolution pixels are indicated by a broken line. In the first row, three low resolution pixels PXLa to PXLc are arranged in a row from the left to the right. In the second row, three low resolution pixels PXLd to PXLf are arranged in a row from the left to the right.

Characters representing colors are assigned to the high resolution pixels, respectively. K represents a “black”, B represents a “blue” and R represents a “red”. As illustrated in FIG. 10, the first pixel PXLa includes three Bs and one K. The second pixel PXLb includes two Ks, one B and one R. The third pixel PXLc includes three Rs and one K. In addition, the fourth pixel PXLd includes only K, the fifth pixel PXLe includes only K, and the sixth pixel PXLf includes only R. In the example of FIG. 10, it is assumed that the low resolution pixels representing a multi-color are the three low resolution pixels PXLa to PXLc. The colors included in the multi-color low resolution pixels are three colors of K, B and R.

The right upper of FIG. 10 illustrates the color list CLL. In the color list CLL, all colors (in the example of FIG. 10, three colors of K, B and R) included in the multi-color low resolution pixels are exemplified. Further, each color corresponds to the total number of the multi-color low resolution pixels including the colors. In the example of FIG. 10, the number of the pixels including K is “3 (PXLa to PXLc)”, the number of the pixels including B is “2 (PXLa and PXLb)”, and the number of the pixels including R is “2 (PXLb and PXLc)”. The data creating unit 112 (FIG. 1) analyzes the original raster data RDA (or the input data ID) to specify such a relationship between the colors and the number of the pixels.

Next, the data creating unit 112 (FIG. 1) selects a color corresponding to the maximum number of pixels as the representative color. In the example of FIG. 10, K (black) is selected as the representative color RCL. Then, the data creating unit 112 creates the image data DH and DL according to the selected representative color. A method of creating the image data DH and DL may employ the methods of the previous embodiments. For example, the pixel PXLb (FIG. 10) including plural colors in addition to the representative color RCL may be processed by employing any one of the processes of FIGS. 6 to 8 (Character CLx of FIG. 10 denotes a determined color). Further, pixels PXLac, PXLbc, PXLcc, PXLdc, PXLec and PXLfc illustrated in the partial area DL3 of FIG. 10 correspond to the pixels PXLa to PXLf illustrated in the partial area RDA3, respectively.

As described above, according to the embodiment, the color, which is most frequently included in the multi-color low resolution pixels, is selected as the representative color, so that a wide image area is represented by the high resolution image data DH with a high pixel density. As a result, a high definition image can be represented while reducing the data amount. An area represented by one multi-color low resolution pixel corresponds to a “multi-color low resolution pixel area” according to the appended claims. Further, the operation of the data creating unit 112 according to the embodiment can be expressed in other words as follows. The data creating unit 112 specifies a multi-color low resolution pixel area including plural pixels of the high resolution (the first pixel density), which correspond to one pixel of the low resolution (the second pixel density) and in which the total number of colors is equal to or larger than 2. Then, the data creating unit 112 selects the color, which is most frequently included in the multi-color low resolution pixels among colors of the pixels of the high resolution (the first pixel density), as the representative color.

### F. Modification

Since, among elements in the previous embodiments, elements other than elements claimed in the independent claims are additional, the elements may be omitted. Further, the invention is not limited to the previous embodiments and various modifications can be made within the scope of the invention. For example, the following modifications can be made.

### Modification 1

Differently from the embodiment as illustrated in FIGS. 6 and 7, in relation to the low resolution pixels including plural colors in addition to the representative color, a color (pixel value) set in the low resolution pixels of the low resolution image data DL is not limited to the most frequent color and the average color, and may employ one of colors obtained by synthesizing the colors other than the representative color. Herein, the term “colors obtained by synthesizing the colors other than the representative color” means the term “colors represented by a function of pixel values of the colors other than the representative color”. Such a function may employ various functions. For example, it is possible to employ a function which returns an average, a function which returns a maximum value, a function which returns a mode, a function which returns a minimum value, or a function which returns a median. Herein, the function may be set in each color component. Further, it may be possible to employ a function which uses a position of a pixel in addition to a pixel value as an argument. For example, after a priority is assigned in advance to plural high resolution pixels in low resolution pixels, it may be possible to employ a function which returns a color of a pixel with the highest priority among the high resolution pixels representing colors other than the representative color.

Further, Differently from the embodiment as illustrated in FIG. 8, in relation to the low resolution pixels including plural colors in addition to the representative color, the color (pixel value) set in the low resolution pixels of the low resolution image data DL is not limited to the most frequent color, and may employ one arbitrarily selected from the colors other than the representative color. However, if the most frequent color is employed, the total number of high resolution pixels, which have pixel values set in the high resolution image data DH, can be reduced.

### Modification 2

Differently from the previous embodiments, the information included in the high resolution image data DH to specify a pixel of the representative color is not limited to the flag, and may employ various kinds of information. For example, a list of identification numbers of high resolution pixels representing the representative color may be employed as the high resolution image data DH. Further, information indicating the positions of high resolution pixels representing the representative color may be employed as the high resolution image data DH. In any case, it is preferred that the data creating unit 112 supplies the data synthesizing unit 224 with data representing the gray scale value (pixel value) of the representative color in addition to the image data DH and DL. Further, data representing pixel values of a part of high resolution pixels (including the pixel of the representative color) may be employed as the high resolution image data DH. In such a case, the pixel representing the representative color is specified by the gray scale value representing the representative color. Further, in such a case, since plural pixels representing the same gray scale value are continued, the high resolution image data can be compressed with high efficiency. In any case, the colors of the high resolution pixels are specified by the high resolution image data DH.

In any case, in relation to the high resolution pixels, which have colors specified by the high resolution image data DH, the data synthesizing unit 224 (FIG. 1) selects pixel values representing the specified colors. In relation to the high resolution pixels, which have colors not specified by the high resolution image data DH, the data synthesizing unit 224 selects pixel values specified by the low resolution image data DL. In this way, the data synthesizing unit 224 can reproduce an image from the image data DH and DL. Further, data of pixels, pixel values and flags of which are not set, may be deleted from the image data DH and DL.

### Modification 3

Differently from the previous embodiments, compression/decompression algorithm by the data compression unit 114 (FIG. 1) and the data development unit 222 is not limited to the run length encoding, and various algorithms (e.g., Huffman coding) may be employed. In any case, it is preferred to employ a lossless compression algorithm. Further, an object to be compressed is at least one of the high resolution image data DH and the low resolution image data DL. For example, both the image data DH and DL may be compressed. Further, such compression elements (the data compression unit 114 and the data development unit 222) may be omitted. In this regard, it is preferred to compress at least one of the image data DH and DL. In this way, although a band of a data transmission path TL (e.g., the transmission path TL of FIG. 1) is narrow, the image data DH and DL can be transmitted at a high speed. Further, the capacity of a memory area used for storing the image data DH and DL can be reduced.

### Modification 4

Differently from the previous embodiments, the input data ID is not limited to the PDL format, and various formats may be employed. For example, raster data may be employed as the input data ID. When the pixel density of the input data ID is different from the pixel density of the high resolution image data DH, it is preferred that the data creating unit 112 (FIG. 1) specifies the pixel values (the original raster data RDA) of each pixel of the high resolution through the resolution conversion process of the input data ID.

Further, the resolution of the high resolution image data DH may be different from 2400 dpi and the resolution of the low resolution image data DL may be different from 600 dpi. In general, it is preferred that the resolution (the pixel density) of the high resolution image data DH is higher than the resolution (the pixel density) of the low resolution image data DL. Herein, the resolution in the longitudinal direction may be different from the resolution in the transverse direction. In such a case, in at least one of the longitudinal direction and the transverse direction, it is preferred that the resolution of the high resolution image data DH is higher than the resolution of the low resolution image data DL. In any one of the longitudinal direction and the transverse direction, the resolution of the high resolution image data DH may be identical to the resolution of the low resolution image data DL. In any case, in the respective longitudinal and transverse directions, it is preferred that the resolution (pixel density) of the high resolution image data DH is L (L is an integer equal to or larger than 1) times as high as the resolution (pixel density) of the low resolution image data DL. Further, the color components of the pixel values are not limited to R, G and B, and may employ other components.

### Modification 5

Differently from the previous embodiments, the configuration of an image processing system is not limited to the configuration as illustrated in FIG. 1, and may employ various configurations. For example, a part of the elements of the computer 100 may be provided in the printing apparatus 200. In contrast, a part of the elements of the printing apparatus 200 may be provided in the computer 100. Further, the computer 100 and the printing apparatus 200 may be incorporated in one apparatus. Furthermore, the data compression unit 114 and the data development unit 222 may be omitted. In addition, the data synthesizing unit 224 may be provided in an apparatus different from any one of the printing apparatus 200 and the computer 100.

In any case, the image processing apparatus provided with the data creating unit 112 creating the image data DH and DL is used, so that it is possible to reduce a problem occurring when using the high resolution image data DH and the low resolution image data DL (e.g., the data amount can be reduced). Further, the image processing apparatus provided with the data synthesizing unit 224, which synthesizes the image data DH and DL by giving priority to a gray scale value specified by the high resolution image data DH, is used, so that an image can be reliably reproduced.

Further, the synthesized raster data RDC (FIGS. 1 and 3) is not used only for the purpose of printing, and may be used in various purposes. For example, a display apparatus may display an image according to the synthesized raster data RDC. As described above, it is possible to use various image output units that output (display or print) an image according to the synthesized raster data RDC. The image output unit may be a different apparatus from the processing apparatus provided with the data synthesizing unit 224.

Further, a method of transmitting the image data DH and DL from the data creating unit 112 to the data synthesizing unit 224 can be implemented in various ways. For example, instead of the transmission path TL (FIG. 1), a detachable memory (e.g., a USB memory) may be used. In such a case, the computer 100 and the printing apparatus 200 may be provided with interfaces to which the memory is connected. Further, the data creating unit 112 and the data synthesizing unit 224 may be provided in the same apparatus. In such a case, a memory (e.g., a common memory), which can be referred to from both the data creating unit 112 and the data synthesizing unit 224, may be used.

### Modification 6

Differently from the previous embodiments, a part of the configuration realized by hardware may be replaced with software, and, in contrast, a part or the whole of the configuration realized by software may be replaced with hardware. For example, the function of the data creating unit 112 of FIG. 1 may be realized by a hardware circuit provided with a logic circuit.

Further, when a part or the whole of the function of the invention is realized by software, the software (computer program) can be stored in a computer-readable recording medium and provided. According to the invention, the “computer-readable recording medium” is not limited to a portable recording medium such as a flexible disk or a CD-ROM, and may include an internal recording device (e.g., various RAMs and ROMs) in a computer and an external recording device (e.g., a hard disk) fixed to the computer.

The disclosure of Japanese Patent Application No. 2009-033591 filed Feb. 17, 2009 including specification, drawings and claims is incorporated herein by reference in its entirety.

What is claimed is:

1. An image processing apparatus comprising:
a data creating unit that creates image data in response to input data representing an image,
wherein the image data includes first image data of a first pixel density and a second image data of a second pixel density lower than the first pixel density, and
the data creating unit selects a representative color from colors included in the image, creates data, which includes information for specifying a high resolution pixel representing a portion indicating the representative color of the image among a plurality of high resolution pixels arranged with the first pixel density in an image area representing the image, as the first image data, and creates data, which includes a pixel value of a low resolution pixel representing a portion indicating a color different from the representative color of the image among a plurality of low resolution pixels arranged with the second pixel density in the image area, as the second image data.

2. The image processing apparatus according to claim 1, wherein the data creating unit specifies a multi-color low resolution pixel region of the image area, which includes the plurality of pixels of the first pixel density corresponding to one pixel of the second pixel density and having at least two colors, and selects a color, which is most frequently included in the multi-color low resolution pixel region among colors of the pixels of the first pixel density, as the representative color.

3. The image processing apparatus according to claim 1, wherein the data creating unit selects a most common color visible among colors of the pixels of the first pixel density in the image area as the representative color.

4. The image processing apparatus according to claim 1, wherein the data creating unit selects the second pixel density from a plurality of pixel density candidates prepared in advance to create the second image data such that a total number of colors, other than the representative color, of the pixels of the first pixel density is equal to or less than 1 in a region of the image area, which includes the plurality of pixels of the first pixel density corresponding to one pixel of the second pixel density.

5. The image processing apparatus according to claim 1, wherein, when a total number of colors other than the representative color of the pixels of the first pixel density is equal to or larger than 2 in a region of the image area, which includes the plurality of pixels of the first pixel density corresponding to one pixel of the second pixel density, the data creating unit sets the pixel value of the low resolution pixel in the second image data as a value representing one color obtained by synthesizing colors other than the representative color.

6. The image processing apparatus according to claim 1, wherein, when a total number of colors other than the representative color of the pixels of the first pixel density is equal to or larger than 2 in a region of the image area, which includes the plurality of pixels of the first pixel density corresponding to one pixel of the second pixel density,
the data creating unit selects one from the colors other than the representative color to set the pixel value of the low resolution pixel in the second image data as a value representing the selected color, and sets a pixel value of the high resolution pixel in a position, which represents a remaining color different from the representative color and the selected color, among the high resolution pixels in the first image data as a value representing the remaining color.

7. An image processing system comprising:
a data creating unit that creates image data in response to input data representing an image; and
a data synthesizing unit,
wherein the image data includes first image data of a first pixel density and a second image data of a second pixel density lower than the first pixel density,
the data creating unit selects a representative color from colors included in the image, creates data, which includes information for specifying a high resolution pixel representing a portion indicating the representative color of the image among a plurality of high resolution pixels arranged with the first pixel density in an image area representing the image, as the first image data, and creates data, which includes a pixel value of a low resolution pixel representing a portion indicating a color different from the representative color of the image among a plurality of low resolution pixels arranged with the second pixel density in the image area, as the second image data, and
the data synthesizing unit creates synthesized image data of the first pixel density, which represents the image, by synthesizing the first image data with the second image data, and creates the synthesized image data by selecting a pixel value representing a specified color in relation to the high resolution pixels in which the color is specified by the first image data, and by selecting a pixel value specified by the second image data in relation to the high resolution pixels in which the color is not specified by the first image data.

8. An image processing apparatus comprising:
a data synthesizing unit that synthesizes first image data of a first pixel density with a second image data of a second pixel density lower than the first pixel density, thereby creating synthesized image data of the first pixel density representing an image,
wherein the first image data includes information for specifying a high resolution pixel representing a portion indicating a representative color among a plurality of high resolution pixels arranged with the first pixel density in an image area representing the image,
the second image data includes a pixel value of a low resolution pixel representing a portion indicating a color different from the representative color of the image among a plurality of low resolution pixels arranged with the second pixel density in the image area, and
the data synthesizing unit selects a pixel value representing a specified color in relation to the high resolution pixels in which the color is specified by the first image data, and selects a pixel value specified by the second image data in relation to the high resolution pixels in which the color is not specified by the first image data, thereby creating the synthesized image data.

9. A printing apparatus that performs printing based on the data created by the image processing apparatus according to claim 1.

10. A printing apparatus that performs printing based on the synthesized image data created by the image processing apparatus according to claim 8.
